(19) United States
(12) Patent Application Publication
(10) Pub. No.: US 2005/0259603 A1
(43) Pub. Date: Nov. 24, 2005

(54) System, method and computer program product for wireless automated introductions

(75) Inventors: Mark Joseph Hamzy, Round Rock, TX (US); Dustin C. Kirkland, Austin, TX (US); Emily Jane Ratliff, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/850,392

(22) Filed: May 20, 2004

(51) Int. Cl. H04B 7/00

(52) U.S. Cl. 370/310

(57) ABSTRACT

A method, computer program product, and a data processing system for distributing attendee information for use in a physical encounter involving multiple attendees is provided. An identifier assigned to a first data processing system associated with a first attendee is received by wireless transmission. A query including the identifier is formulated. The query is executed on an attendee database. A record of the database including an identity of the first attendee is wirelessly transmitted to a second data processing system associated with a second attendee responsive to execution of the query.

### BACKGROUND OF THE INVENTION

1. Technical Field

The present invention relates generally to an improved data processing system and in particular to a method and computer program product for automating wireless electronic introductions via portable data processing systems.

2. Description of Related Art

Wireless communication devices are becoming increasingly common peripheral features of mobile computing platforms. For example, wireless fidelity (Wi-Fi) communication cards compatible with local area network (LAN) protocols, such as 802.11a or 802.11b that use the Ethernet protocol, allow mobile computational devices, such as a notebook computer or another suitably equipped mobile data processing system, access to a high-frequency wireless local area network (WLAN). WLAN is gaining acceptance as an alternative to wired LANs.

In many corporate environments, numerous attendees having WLAN enabled laptop computers will gather for a business meeting or other event within range of a WLAN. Applications for wirelessly exchanging electronic introductions, e.g., business or contact information, between attendees have previously been developed. However, such information exchanges require user interaction with the mobile platform to facilitate the information exchange.

Thus, it would be advantageous to provide a method and system for automating the exchange of user information of users associated with mobile data processing platforms in a wireless local area network.

### SUMMARY OF THE INVENTION

The present invention provides a method, computer program product, and a data processing system for distributing attendee information for use in a physical encounter involving multiple attendees. An identifier assigned to a first data processing system associated with a first attendee is received by wireless transmission. A query including the identifier is formulated. The query is executed on an attendee database. A record of the database including an identity of the first attendee is wirelessly transmitted to a second data processing system associated with a second attendee responsive to execution of the query.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented.

FIG. 2 is a block diagram of a data processing system that may be implemented as a server in accordance with a preferred embodiment of the present invention;

FIG. 3 a pictorial representation of a data processing system in which an automated introduction routine may be implemented in accordance with a preferred embodiment of the present invention;

FIG. 4 is a block diagram of the data processing system shown in FIG. 3 in which a preferred embodiment of the present invention may be implemented;

FIG. 5 is a diagrammatic illustration of a database maintained by a client that facilitates automated introductions between mobile data processing systems in accordance with a preferred embodiment of the present invention;

FIG. 6 is a diagrammatic illustration of a table created by the automated introduction routine for accumulating information of users associated with mobile computers within communication range of a client running an instance of the automated introduction routine in accordance with a preferred embodiment of the present invention;

FIG. 7 is a flowchart of processing performed by an automated introduction routine for broadcasting a client identifier associated with a user in accordance with a preferred embodiment of the present invention; and

FIG. 8 is a flowchart of processing performed by the automated introduction routine for obtaining user information of a user associated with a client identifier in accordance with a preferred embodiment of the present invention.

### DETAILED DESCRIPTION OF THE PREFERRED EMBODIMENT

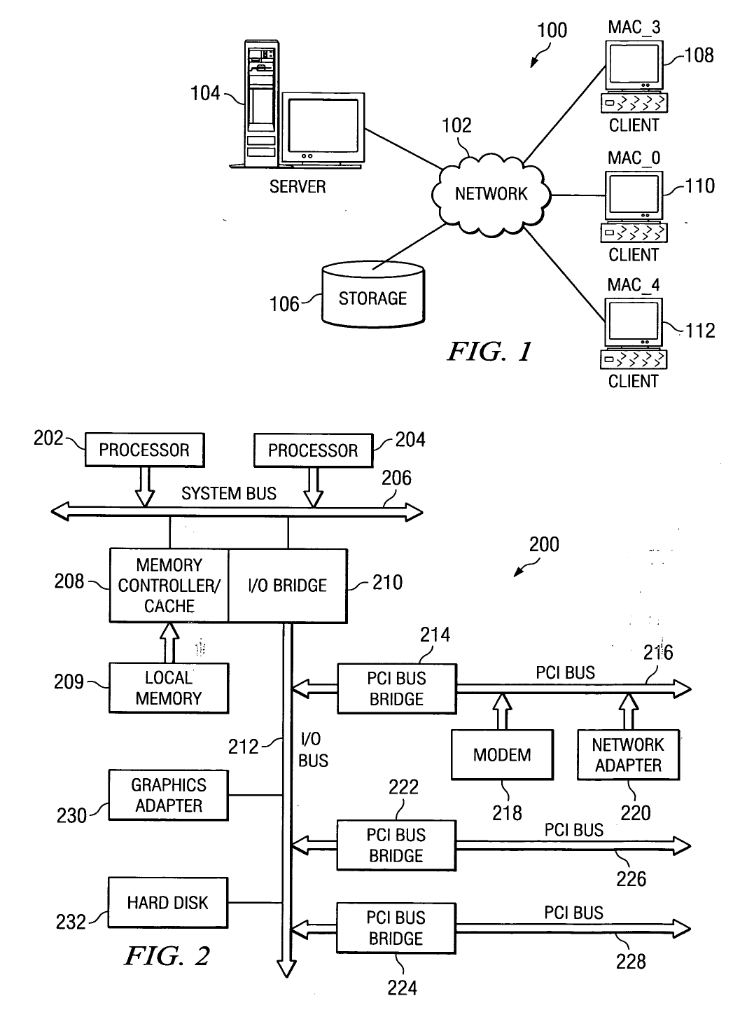

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. Clients 108, 110, and 112 have addresses, such as Ethernet addresses, Internet protocol address, media access control (MAC) addresses, or the like. In the depicted example, clients 108, 110, and 112 have respective MAC addresses of MAC_{—}3, MAC_{—}0, and MAC_{—}4. Server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). Preferably, clients 108, 110, and 112 connect with server 104 via wireless access to network 102 and network 102 thus includes a wireless access point, such as a wireless access point router. For example, network 102 may provide a WiFi hotspot and is accordingly equipped with a wireless access point router. Accordingly, clients 108, 110, and 112 may access server 104 by wireless Internet mechanisms. FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

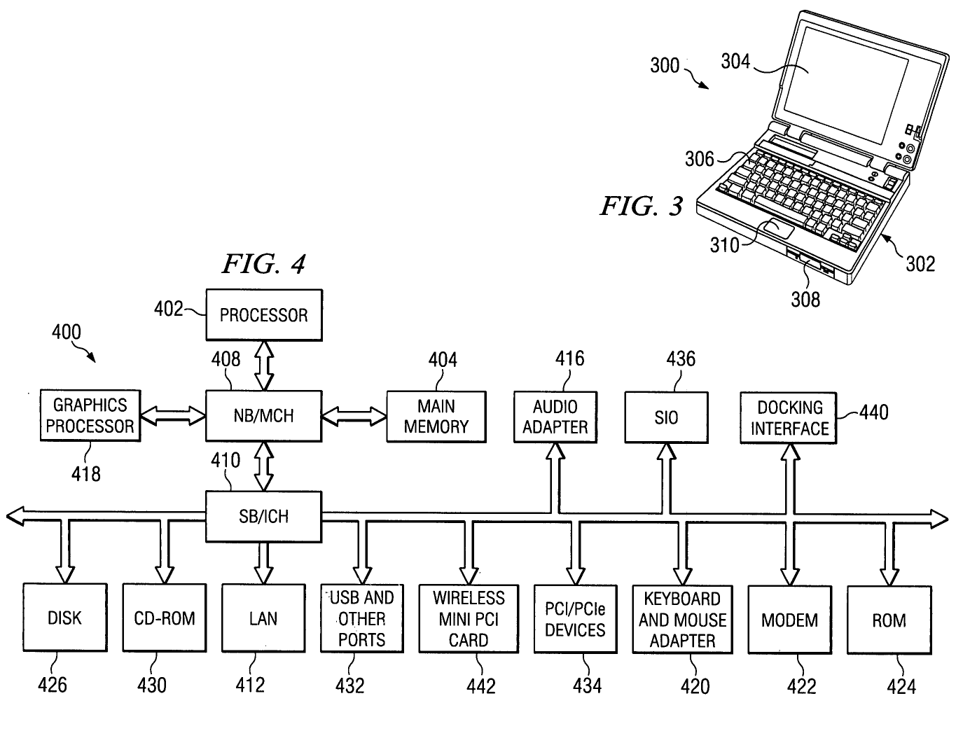

With reference now to the figures and in particular with reference to FIG. 3, a pictorial representation of a data processing system in which the present invention may be implemented is depicted in accordance with a preferred embodiment of the present invention. Mobile computer 300 is an example of a client, such as client 108 shown in FIG. 1, adapted to perform automated introductions according to embodiments of the invention. A mobile computer 300 is depicted which includes system unit 302, video display terminal 304, keyboard 306, storage devices 308, which may include floppy drives and other types of permanent and removable storage media, and pointer device 310. Mobile computer 300 is an example of a client, such as client 308, 310, or 312 of FIG. 3. Additional input devices may be included with mobile computer 300, such as, for example, a mouse, joystick, touch screen, trackball, microphone, and the like. Mobile computer 300 man be implemented using any suitable computer, such as an IBM Thinkpad computer, which is a product of International Business Machines Corporation, located in Armonk, N.Y. Computer 300 also preferably includes a graphical user interface (GUI) that may be implemented by means of systems software residing in computer readable media in operation within computer 300.

With reference now to FIG. 4, a block diagram of a data processing system is shown in which the present invention may be implemented. Data processing system 400 is an example of a mobile computer, such as computer 300 in FIG. 3, in which code or instructions implementing the processes of the present invention may be located. In the depicted example, data processing system 400 employs a hub architecture including a north bridge and memory controller hub (MCH) 408 and a south bridge and input/output (I/O) controller hub (ICH) 410. Processor 402, main memory 404, and graphics processor 418 are connected to MCH 408. Graphics processor 418 may be connected to the MCH through an accelerated graphics port (AGP), for example.

In the depicted example, local area network (LAN) adapter 412, audio adapter 416, keyboard and mouse adapter 420, modem 422, read only memory (ROM) 424, hard disk drive (HDD) 426, CD-ROM driver 430, universal serial bus (USB) ports and other communications ports 432, wireless mini PCI card 442, and PCI/PCIe devices 434 may be connected to ICH 410. PCI/PCIe devices may include, for example, Ethernet adapters, add-in cards, PC cards for notebook computers, etc. PCI uses a cardbus controller, while PCIe does not. Wireless mini PCI card 442 may be implemented as, for example, a Cisco Aironet Wireless 802.11b mini PCI card manufactured by International Business Machines of Armonk, N.J. ROM 424 may be, for example, a flash binary input/output system (BIOS). Hard disk drive 426 and CD-ROM drive 430 may use, for example, an integrated drive electronics (IDE) or serial advanced technology attachment (SATA) interface.

Docking interface 440 may also be connected to the ICH. Data processing system 400 may be a mobile computing device, such as a laptop computer or handheld computer. Docking interface 440 provides port replication to allow the data processing system to easily connect to a keyboard, pointing device, monitor, printer, speakers, etc. The docking interface allows the mobile computing device to operate as a desktop computer with the more immobile peripheral devices.

An operating system runs on processor 402 and is used to coordinate and provide control of various components within data processing system 400 in FIG. 4. The operating system may be a commercially available operating system such as Windows XP, which is available from Microsoft Corporation. An object oriented programming system such as Java may run in conjunction with the operating system and provides calls to the operating system from Java programs or applications executing on data processing system 400. “Java” is a trademark of Sun Microsystems, Inc. Instructions for the operating system, the object-oriented programming system, and applications or programs are located on storage devices, such as hard disk drive 426, and may be loaded into main memory 404 for execution by processor 402. The processes of the present invention are performed by processor 402 using computer implemented instructions, which may be located in a memory such as, for example, main memory 404, memory 424, or in one or more peripheral devices 426 and 430.

Those of ordinary skill in the art will appreciate that the hardware in FIG. 4 may vary depending on the implementation. Other internal hardware or peripheral devices, such as flash memory, equivalent nonvolatile memory, or optical disk drives and the like, may be used in addition to or in place of the hardware depicted in FIG. 4. Also, the processes of the present invention may be applied to a multiprocessor data processing system.

For example, data processing system 400 may be a personal digital assistant (PDA), which is configured with flash memory to provide non-volatile memory for storing operating system files and/or user-generated data. The depicted example in FIG. 4 and above-described examples are not meant to imply architectural limitations. For example, data processing system 200 also may be a tablet computer or telephone device in addition to taking the form of a PDA.

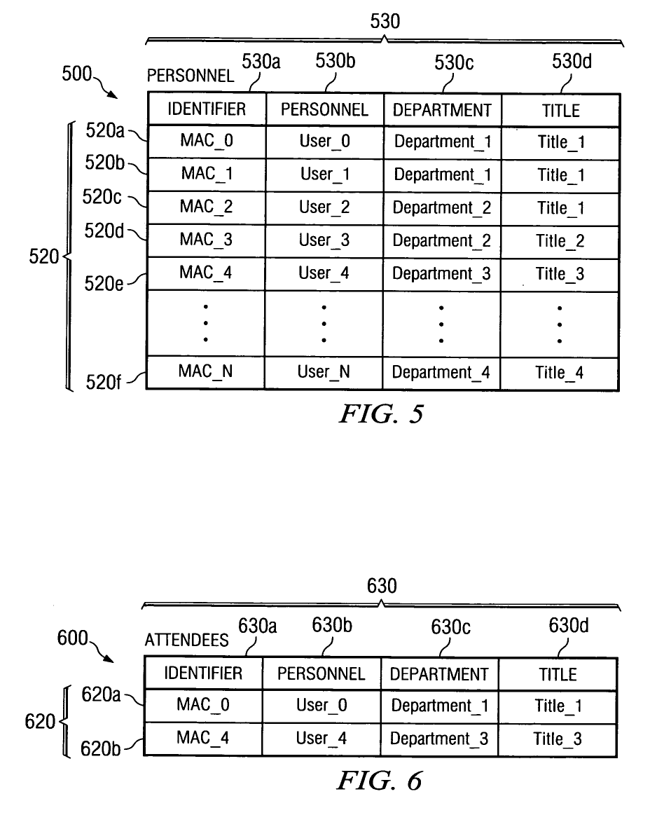

FIG. 5 is a diagrammatic illustration of a database maintained by a server, such as data processing system 200 shown in FIG. 2, that facilitates automated introductions between mobile data processing systems in accordance with a preferred embodiment of the present invention. Table 500 is a central repository of personnel records and associated identifiers of computers or other assets assigned to personnel that may be attendees of a meeting or other physical encounter within a corporation or other entity. Table 500 stores information on persons, such as employee identities, employee contact data, or other personal information of persons associated with a business or other entity. Table 500 may be implemented as, for example, a lightweight directory access protocol (LDAP) personnel database.

Table 500 comprises a plurality of records 520 and fields 530. Table 500 is stored by, or is otherwise communicatively couple with, a server, such as on hard disk 232 of data processing system 200, fetched therefrom by processor 202 or 204, and processed by data processing system 200 shown in FIG. 2. Each record 520a-520f, or row, comprises data elements in respective fields 530a-530d.

Table 500 has a label, or identifier, assigned thereto. In the present example, table 500 has a label of “PERSONNEL.” Fields 530a-530d have a respective label, or identifier, that facilitates insertion, deletion, querying, or other data operations or manipulations of table 500. In the illustrative example, fields 530a-530d have respective labels of “Identifier”, “Personnel”, “Department”, and “Title.” Data elements of a particular field 530a-530d typically share a common data type, e.g., string, integer, float, etc. A particular field, e.g., field 530a, may be designated as a key field and each respective data element, e.g., data-elements MAC_{—}0-MAC_N, is unique within key field 530a. Assignment of unique values to data elements of key-field 530a provides an identifier for records 520a-520f and the collection of data elements of key field 530a is typically referred to as an index. Addressing a particular record 520a-520f via an associated data element, or key, of key field 530a is referred to as indexing of record 520a-520f. Alternatively, a key may be obtained by a function, e.g., a hashing function, that indexes a particular record 520a-520f. Unique identifier values stored in field 530a are respectively assigned to an asset such as a mobile computer and thus provide an association between an asset and a user identified in field 530b and corresponding user information stored in field 530c and 530d.

Table 500 provides a central database or store of personnel records that may be wirelessly accessed by a client, such as client 108. Each record 520a-520f provides an association between a unique client identifier stored in field 530a with a particular user having an identity stored in field 530b. For example, key values maintained in field 530a may comprise Internet protocol (IP) addresses, media access control (MAC) addresses, Ethernet addresses, or other identifiers that are uniquely assigned to respective mobile computers associated with a user identified in field 530b. In the illustrative example, field 530c maintains identifiers of a department in which a user identified in field 530b of a common record is employed. Field 530d maintains identifiers of personnel titles or job positions. Other fields may be included for storing personnel information such as business or home phone numbers, email addresses, photographs, or the like.

An instance of an automated introduction routine implemented as a computer executable instruction set is respectively maintained by clients that interact with each other and server 104 via wireless data exchanges conveyed over network 102. The automated introduction routine is preferably selectively executable by a user of a client mobile computer and provides a user with graphical output of personnel information of users associated with client computers within wireless range of a receiving client. Additionally, the automated introduction routine populates an attendee table or other data structure with personnel records of users associated with other mobile computers within wireless communication range of a client mobile computer running an instance of the automated introduction routine.

Upon invocation of the automated introduction routine, a client computer begins monitoring for receipt via a wireless network device, such as wireless mini PCI card 442, of wireless identifier messages transmitted from other clients, e.g., clients 110 and 112. An identifier message includes an identifier, e.g., a MAC address, associated with a client mobile computer and is used for interrogating table 500 by a client receiving the identifier message.

Various methods may be employed by a client for obtaining identifiers from other clients within wireless communication range of each other. For example, a client may inspect any wirelessly received packet, whether addressed to the receiving client or not, for an identifier, such as a network address, and subsequently obtain personnel information of a user determined to be associated with the identifier. Alternatively, a client may run an instance of the automated introduction routine adapted to periodically, for example at every 60 second interval, broadcast an identifier message. Other clients within reception range may interrogate a central database, such as table 500 maintained by server 104, for the personnel information of the user associated with the identifier upon receipt of a periodically transmitted identifier message.

On receipt of an identifier message by a client, the automated introduction routine running on the client formulates a query, such as a structured query language (SQL)-formatted query, and interrogates table 500 with the query. Assume that after invocation of an instance of the automated introduction routine by client 108, an identifier message containing the identifier MAC_{—}0 is received by client 108. A query is formulated by the automated introduction routine instance running on the receiving client 108 that uses the received identifier as an operand for querying table 500. For example, the query may comprise an SQL query such as the following:
SELECT*FROM PERSONNEL
WHERE Identifier=‘Mac_{—}0’

The query is then transmitted to server 104. The query transmitted to server 104 may be encapsulated in one or more frames formatted for wireless transmission over network 102. For example, the SQL query may be encapsulated in one or more 802.11a or 802.11b frames and transmitted by wireless mini PCI card 402 to server 104 via wireless network infrastructure of network 102. On receipt of the query, server 104 parses the SQL query from the received frame and executes the query on table 500. A return data set obtained from execution of the query is then encapsulated and transmitted to client 108 in a query response message. Client 108 parses the return data set from the query response message upon receipt of the query response message.

In the present example, the following return data set is returned to client 108 by server 104 responsive to execution of the above SQL query on table 500:

| Identifier | Personnel | Department | Title |
|---|---|---|---|
| Mac_0 | User_0 | Department_1 | Title_1 |

The automated introduction routine then parses the user identity and associated personal information from the query response message, formats the parsed data as visualization output, and conveys the visualization output to a display device, such as video display terminal 304.

In accordance with another embodiment of the present invention, the automated introduction routine may create a table upon invocation of the routine, or a suitable command input provided thereto, by the user of client 108. For example, the automated introduction routine may execute the following SQL command to create a table used for storing personnel records of users associated with mobile computers or other computational devices within communication range of client 108 running an instance of the automated introduction routine:
CREATE TABLE ATTENDEES
(
Identifier varchar,
Personnel varchar,
Department varchar,
Title varchar,
)

FIG. 6 is a diagrammatic illustration of a table created by the automated introduction routine for accumulating information of users associated with mobile computers within communication range of a client running an instance of the automated introduction routine in accordance with a preferred embodiment of the present invention. Execution of the create SQL command results in creation of a table ATTENDEES that may be used by client 108 for storing personnel records of users within communication range of client 108. Table 600 as shown is representative of a data structure created by the automated introduction routine and that has subsequently inserted records 620a and 620b. For example, assume a user of client 108 is attending a business meeting and clients 110 and 112 are within communication range of client 108. Upon receipt of an identifier transmitted to client 108 by client 110, the personnel information of the user associated with the identifier of client 110 is obtained from server 104 and displayed to the user of client 108 as described above. Likewise, the personnel information of the user associated with the identifier of client 112 obtained by client 108 from server 104 is displayed to the user of client 108. Additionally, the personnel information of both client 110 and 112 may be added to table 600 as respective records 620a and 620b. For example, upon receipt of identifier Mac_{—}0 by client 108 from client 110, an interrogation of table 500 by server 104 responsive to receipt of a query transmitted to server 104 by client 108 results in a return data set including data of record 520a being transmitted to client 108. The return data set received by client 108 is parsed and displayed on client 108 and is preferably inserted into table 600, for example as record 620a.

Preferably, the automated introduction routine may format the data of table 600 for display on a display device of client 108, such as video display terminal 304. Thus, in addition to displaying the personnel information of users associated with mobile computers within wireless communication range of client 108, records of the users are recorded in table 600 maintained by client 108 thereby providing a record or roster as a graphical visualization output of all attendees of a meeting or other event. In the event that personnel photographs are maintained in records of table 500, inclusion of attendee photographs in table 600 and suitable display thereof by the automated introduction routine provides a mechanism for visually verifying an attendee's identification at a physical encounter of multiple attendees.

In yet another embodiment of the present invention, a first client may transmit a return request for personnel information of the user associated with an identifier of a second client responsive to the first client receiving the identifier assigned to the second client. For example, each client 108, 110, and 112 may store personnel information of a user associated with client 108, 110, and 112, respectively. On receipt of a request for personnel information, the client receiving the request may transmit the personnel information of the user that is stored in the client. Accordingly, personnel information may be exchanged between clients without deployment of a central personnel data repository.

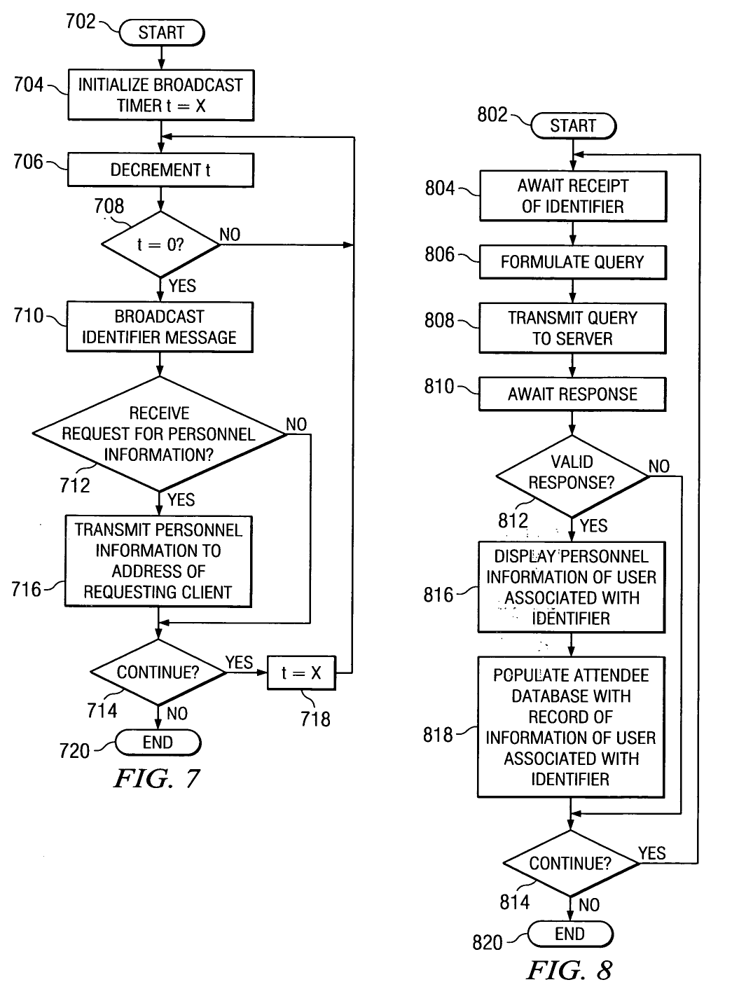

FIG. 7 is a flowchart of processing performed by an automated introduction routine for broadcasting an identifier assigned to a client associated with a user in accordance with a preferred embodiment of the present invention. The automated introduction routine is initialized (step 702), for example upon user invocation of the automated introduction routine by a suitable input supplied to a client. A broadcast timer t is then initialized to a predefined interval value (X) (step 704), and the routine proceeds to decrement the broadcast timer (step 706). An evaluation is made to determine if the broadcast timer has expired (step 708), and the routine returns to decrementing the broadcast timer according to step 706 if the predefined interval has yet to expire. On expiration of the predefined interval, the client then broadcasts an identifier message (step 710), for example an 802.11a or 802.11b formatted frame including the identifier assigned to the client running the automated introduction routine.

The automated introduction routine may additionally evaluate whether any requests for personnel information of a user associated with the client has been requested by another client (step 712). In the event that no request for personnel information has been received by another client, the routine proceeds to evaluate whether the application is to continue running (step 714). The client broadcasts the personnel information of a user associated with the client running the automated introduction routine if a corresponding request has been received (step 716), and the routine then proceeds to step 714 to determine if the routine is to continue running. The automated introduction routine resets the broadcast timer to the predefined interval (step 718) and returns to decrementing the broadcast time according to step 706 if an evaluation is made to continue processing at step 714. Alternatively, the routine exits (step 720).

FIG. 8 is a flowchart of processing performed by the automated introduction routine for obtaining user information of a user associated with a client identifier in accordance with a preferred embodiment of the present invention. The automated introduction routine is initialized (step 802) and awaits receipt of an identifier message (step 804). A query is then formulated with a received identifier (step 806) and is transmitted to a server that includes or interfaces with a remote database, such as table 500, of personnel records (step 808). The client then awaits receipt of a query response message from the server (step 810). Upon receipt of the query response message or on expiration of a suitable time out period, the automated introduction routine evaluates whether a valid response has been received (step 812). In the event that a valid response has not been received, the automated introduction routine determines whether processing is to continue (step 814).

The automated introduction routine displays the personnel information of the user associated with the identifier when a valid response to the query is received (step 816). Additionally, the automated introduction routine may insert a record into a local table maintained by the client running the automated introduction routine (step 818), and processing then returns to step 814 to determine whether processing is to continue. The automated introduction routine returns to step 804 to await receipt of an additional identifier message, or alternatively the automated introduction routine terminates (step 820). Preferably, the user of the client may selectively direct the automated introduction routine to produce a graphic visualization of all records in the Attendees database. Thus, a visual indication of all users with suitably equipped mobile computers running respective instances of the automated introduction routine that are in communication range of the user's client is provided.

Accordingly, the automated introduction routine provides a mechanism for obtaining information associated with users having a mobile computer within wireless communication range of each other. Additionally, the automated introduction routine provides a mechanism of populating a table or other data structure with information of users having respective mobile computers within communication range of each other. The table generated on a client running the automated introduction routine of the present invention advantageously provides information of users that may be commonly attending a business or social event to a user of the introduction routine.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of distributing attendee information for use in a physical encounter involving multiple attendees, comprising the computer implemented steps of:
receiving by wireless transmission an identifier assigned to a first data processing system associated with a first attendee;
formulating a query including the identifier; executing the query on an attendee database; and
responsive to executing the query, wirelessly transmitting a record of the database including an identity of the first attendee to a second data processing system associated with a second attendee.

2. The method of claim 1, wherein the step of receiving further includes:
wirelessly receiving a local area network protocol-formatted frame including the identifier; and
parsing the identifier from the frame.

3. The method of claim 1, further including:
transmitting, via wireless network infrastructure, the query to a data processing system communicatively coupled with the database.

4. The method of claim 3, wherein the step of executing is performed by the data processing system communicatively coupled with the database.

5. The method of claim 1, wherein the record includes personal information associated with the first attendee.

6. The method of claim 1, further including:
generating a graphical visualization of the record; and
outputting the graphical visualization on a display device.

7. The method of claim 1, further including:
inserting the record in a data structure, wherein the data structure includes a plurality of records each including an identity of a respective attendee of a data processing system associated with the respective attendee.

8. A computer program product in a computer readable medium for distributing attendee information for use in a physical encounter involving multiple attendees, the computer program product comprising:
first instructions that wirelessly receive an identifier assigned to a data processing system associated with a first attendee;
second instructions that formulate a query including the identifier in a format for wireless transmission;
third instructions that wirelessly transmit the query to a remote attendee database; and
fourth instructions that wirelessly receive a response to the query, wherein the response includes an identity of the first attendee.

9. The computer program product of claim 8, wherein the fourth instructions parse the identity from the response.

10. The computer program product of claim 8, wherein the second instructions format the query in one of an 802.11a and an 802.11b wireless Ethernet frame.

11. The computer program product of claim 8, wherein the response further includes personal information associated with the first attendee.

12. The computer program product of claim 8, further including:
fifth instructions that generate a graphical visualization of the record; and
sixth instructions that output the graphical visualization on a display device.

13. The computer program product of claim 8, wherein the response includes personal information associated with the first attendee, the computer program product further including:
fifth instructions for generating a data structure for storage of records; and
sixth instructions for inserting the identity and the personal information in a record of the data structure.

14. A data processing system for distributing attendee information for use in a physical encounter involving multiple attendees, comprising:
a memory that contains an automated introduction routine as a set of instructions;
a wireless network adapter adapted to receive a message including an identifier assigned to a data processing system associated with an attendee; and
a processing unit, responsive to execution of the set of instructions, that parses the identifier from the message, formulates a query including the identifier, and conveys the query to the wireless network adapter, wherein the adapter receives a query response message including an identity of the attendee.

15. The data processing system of claim 14, wherein the processing unit, responsive to receipt of the query response message, parses the identity from the query response message.

16. The data processing system of claim 14, further including:
a display device, wherein the processing unit, responsive to receipt of the query response message by the adapter, generates a graphical visualization of the identity and supplies the graphical visualization to the display device.

17. The data processing system of claim 14, wherein the response message includes personal information of the attendee.

18. The data processing system of claim 17, wherein the processing unit is adapted to generate a data structure and insert the identity and the personal information as a record in the data structure.

19. The data processing system of claim 14, wherein the wireless network adapter is a wireless Ethernet card.

20. The data processing system of claim 14, wherein the adapter transmits the query to a remote data processing system via wireless network infrastructure.
